(19) United States
(12) Patent Application Publication
(10) Pub. No.: US 2012/0319478 A1
(43) Pub. Date: Dec. 20, 2012

(54) DC TO DC CONVERTER WITH RIPPLE CANCELLATION

(75) Inventors: Angel Gentchev, Fremont, CA (US); Anthony Stratakos, St. Helena, CA (US); Alexander Ikriannikov, Castro Valley, CA (US)

(73) Assignee: VOLTERRA SEMICONDUCTOR CORPORATION, Fremont, CA (US)

(21) Appl. No.: 13/164,388

(22) Filed: Jun. 20, 2011

(51) Int. Cl. H02J 1/10; H01F 38/14

(52) U.S. Cl. 307/28; 323/361

(57) ABSTRACT

Ripple cancellation techniques are described for various DC to DC converters having multiple parallel phases with magnetically coupled inductors.

### BACKGROUND OF THE INVENTION

The present invention relates generally to switching power supplies and, in particular, to DC to DC converters with ripple cancellation.

Voltage regulators and other power supplies, such as direct current (DC) to DC converters, are used to provide stable voltage or current sources for electronic devices and systems. The typical purpose of a voltage regulator is to convert a source voltage, such as the voltage of an alternating current (AC) or DC power source, into the operating DC voltage of an electronic device. Switching voltage regulators, often referred to as “switching regulators,” are a type of DC to DC converter that convert one DC voltage to another DC voltage with high efficiency. A switching regulator generates an output voltage by converting an input DC voltage into a high frequency voltage, and filtering the high frequency voltage to produce the output DC voltage.

Conventional switching regulators typically include a switch for alternately coupling and decoupling an input DC voltage source (which may be unregulated), such as a battery, to a load, such as an integrated circuit. An output filter, typically including an inductor and a capacitor, is coupled between the switch and the load to filter the output of the switch and thus provide the output DC voltage. The switching regulator operates on the principle of storing energy in the inductor during one portion of a cycle and then transferring the stored energy to the capacitor and the load in the next portion of the cycle. The output filter serves to attenuate any ripple to an acceptable value at the output.

### SUMMARY OF THE INVENTION

According to a particular class of embodiments, a DC to DC converter is configured to convert a first voltage, V1, to a second voltage, V2. The DC to DC converter includes a first stage and a second stage, the second stage being configured to generate V2 and including N parallel phases. Each of the N parallel phases includes an inductor and switching circuitry configured to define a conduction interval corresponding to a duty cycle D. The conduction intervals of the respective N parallel phases are substantially evenly distributed over 360 degrees. The inductors of all of the N parallel phases are magnetically coupled to each other. The duty cycle D is about M/N, where M is an integer, 0<M<N.

According to another class of embodiments, a DC to DC converter is configured to convert a first voltage, V1, to a second voltage, V2. The DC to DC converter includes N parallel phases configured to receive V1 and generate V2. Each of the N parallel phases includes an inductor and switching circuitry configured to define a conduction interval corresponding to a duty cycle D. The conduction intervals of the respective N parallel phases are substantially evenly distributed over 360 degrees. The inductors of all of the N parallel phases are magnetically coupled to each other. The duty cycle D is about M/N, where M is an integer, 0<M<N.

According to another class of embodiments, an electronic system includes a plurality of DC to DC converters configured to generate a plurality of different DC voltages for use by a plurality of loads. A first one of the DC to DC converters includes N parallel phases configured to receive an input voltage, V1, and generate an intermediate voltage, Vint. Each of the N parallel phases includes an inductor and switching circuitry configured to define a conduction interval corresponding to a duty cycle D. The conduction intervals of the respective N parallel phases are substantially evenly distributed over 360 degrees. The inductors of all of the N parallel phases are magnetically coupled to each other. The duty cycle D is about M/N, where M is an integer, 0<M<N. The electronic system further includes a bus for distributing Vint to others of the DC to DC converters for generation of at least some of the plurality of different DC voltages.

According to yet another class of embodiments, an electronic system includes a plurality of DC to DC converters configured to generate a plurality of different DC voltages for use by a plurality of loads. A particular one of the DC to DC converters includes N parallel phases configured to receive a distribution voltage, Vdist, and generate an output voltage, Vout, for use by a corresponding one of the loads. Each of the N parallel phases includes an inductor and switching circuitry configured to define a conduction interval corresponding to a duty cycle D. The conduction intervals of the respective N parallel phases are substantially evenly distributed over 360 degrees. The inductors of all of the N parallel phases are magnetically coupled to each other. The duty cycle D is about M/N, where M is an integer, 0<M<N. The electronic system further includes a bus for distributing Vdist to others of the DC to DC converters for generation of at least some of the plurality of different DC voltages.

According to a further class of embodiments, a DC to DC converter is configured to convert a first voltage, V1, to a second voltage, V2. The DC to DC converter includes N parallel phases configured to receive V1 and generate V2. Each of the N parallel phases includes an inductor and switching circuitry configured to define a conduction interval corresponding to a duty cycle. The inductors of all of the N parallel phases are magnetically coupled to each other. The DC to DC converter further includes closed-loop control circuitry configured to maintain V2 with reference to one or more operational parameters of the N parallel phases, and to maintain currents associated with each of the N parallel phases to be substantially equal, thereby maintaining a substantially zero ripple current condition in the switching circuitry and the output conductors of the N parallel phases.

According to a still further class of embodiments, a DC to DC converter is configured to convert a first voltage, V1, to a second voltage, V2. The DC to DC converter includes N parallel phases configured to receive V1 and generate V2. Each of the N parallel phases includes an inductor and switching circuitry. The inductors of all of the N parallel phases are magnetically coupled to each other. The DC to DC converter further includes closed-loop control circuitry configured to maintain currents associated with each of the N parallel phases to be substantially equal by sensing the current associated with each of the phases and switching a first one of the N parallel phases in response to the corresponding current crossing a threshold.

According to another class of embodiments, a DC to DC converter is configured to convert a first voltage, V1, to a second voltage, V2. The DC to DC converter includes N parallel phases configured to receive V1 and generate V2. Each of the N parallel phases includes an inductor and switching circuitry. The inductors of all of the N parallel phases are magnetically coupled to each other. The DC to DC converter further includes closed-loop control circuitry configured to maintain currents associated with each of the N parallel phases to be substantially equal by computing an average of the currents and forcing each of the currents toward the average.

According to yet another class of embodiments, a DC to DC converter is configured to convert a first voltage, V1, to a second voltage, V2. The DC to DC converter includes N parallel phases configured to receive V1 and generate V2. Each of the N parallel phases includes an inductor and switching circuitry. The inductors of all of the N parallel phases are magnetically coupled to each other. The DC to DC converter further includes closed-loop control circuitry configured to maintain currents associated with each of the N parallel phases to be substantially equal by sensing the current associated with each of the phases and switching a first one of the N parallel phases on in response to the corresponding current being a lowest one of the currents of all of the phases.

For embodiments including multiple stages, at least one additional stage may include K parallel phases, each of which includes an inductor and switching circuitry configured to define a conduction interval. The conduction intervals of the respective K parallel phases are substantially evenly distributed over 360 degrees. The inductors of all of the N parallel phases are magnetically coupled to each other. And for at least some of these embodiments, each of the conduction intervals of the K parallel phases corresponds to a duty cycle D2 of about L/K, where L is an integer, 0<L<K.

The DC to DC converters associated with various classes of embodiments employ one or more of a Buck topology, a boost topology, a Buck-boost topology, or an isolated topology.

A further understanding of the nature and advantages of the present invention may be realized by reference to the remaining portions of the specification and the drawings.

### BRIEF DESCRIPTION OF THE DRAWINGS

The included drawings are for illustrative purposes and serve only to provide examples of possible structures and process steps for the disclosed inventive devices, circuits, components, systems, and methods. These drawings in no way limit any changes in form and detail that may be made to the invention by one skilled in the art without departing from the spirit and scope of the present invention.

FIG. 1 is a simplified diagram of a DC to DC converter that may be employed with various embodiments of the invention.

FIG. 2 is an example of an output current ripple waveform for the DC to DC converter of FIG. 1.

FIG. 3 includes a simplified representation of a DC to DC converter with two phases configured in parallel along with representations of waveforms associated with each.

FIG. 4 is a graph illustrating a relationship between total output current ripple and conversion ratio/duty cycle for different numbers of parallel phases.

FIG. 5 is a graph illustrating a relationship between the output current ripple for one of two parallel phases and duty cycle for different values of inductor coupling.

FIGS. 6(a) and 6(b) are simplified representations of examples of magnetically coupled inductors that may be employed with specific embodiments of the invention.

FIG. 7 is simplified representation of a cascaded DC to DC converter according to a specific embodiment of the invention.

FIGS. 8(a) and 8(b) are simplified representations of cascaded DC to DC converters according to further specific embodiments of the invention.

FIG. 9 is a simplified representation of a cascaded DC to DC converter according to still another specific embodiment of the invention.

FIG. 10(a) illustrates the relationship among the duty cycles of five parallel phases according to a particular embodiment of the invention.

FIG. 10(b) includes high level diagrams of circuits that may be employed to control duty cycles of parallel phases according to various embodiments of the invention.

FIG. 10(c) illustrates the relationship among the duty cycles of five parallel phases according to various embodiments of the invention.

FIGS. 11(a) and 11(b) are simplified representations of open-loop control circuits that may be used with various embodiments of the invention.

FIG. 12 is a simplified representation of a closed-loop control circuit that may be used with various embodiments of the invention.

FIG. 13 illustrates operation of a control circuit that may be used with specific embodiments of the invention.

FIG. 14 is a simplified representation of a closed-loop control circuit that may be used with various embodiments of the invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

Various embodiments of the invention relate to DC to DC converters and specific mechanisms to facilitate voltage conversion with higher efficiency, smaller solution size and/or lower solution cost. Embodiments of the invention are generally described herein in relation to DC to DC converters that employ Buck topologies (also referred to as Buck converters) which convert an input DC voltage to a lower output DC voltage of the same polarity. It should be understood, however, that embodiments are contemplated in which other topologies are employed in various combinations. Embodiments also may include converters with boost topologies, Buck-boost topologies, and isolated topologies, and in various combinations. The present invention should therefore not be limited by references to specific topologies herein.

DC to DC converters constructed in accordance with embodiments of the present invention incorporate a power switch. In some implementations, the power switch includes a “high side” switch component. The high side switch component is generally coupled to an input supply voltage, that is, an input voltage source, to be converted and/or regulated. In some implementations, the power switch also includes a “low side” switch component. As will be understood by those of skill in the art, a wide range of devices may be used to implement the power switch and/or the high side and low side switch components of a DC to DC converter including a wide range of transistors and diodes.

In some contexts, the power switch is simply referred to as a “switch” or “switching circuit(ry).” Also, an individual high side or low side switch component can be referred to herein as a high side or low side “switch.” Also, as used herein, “power switch” can sometimes refer to the individual high side switch or low side switch component. The terms, “switch component” and “switch,” are generally intended to encompass one or more transistors, diodes, and/or other circuit elements configured to perform the described coupling and de-coupling of the output filter to a first voltage (e.g., the input voltage source to be converted and/or regulated), alternating with coupling and de-coupling to a second voltage such as ground, as described below.

In some embodiments, the power switch is configured in a way such that it alternately couples the output filter to the input voltage source and a second voltage, which is often ground. According to specific embodiments, the high side switch selectively couples the output filter to the input voltage, while the low side switch selectively couples the output filter to ground. The ratio of time spent with the “high side” switch enabled versus the “low side” switch enabled (i.e., the duty cycle) determines the output voltage developed, for instance, by an output LC filter coupled at the outputs of both the high side and low side switches.

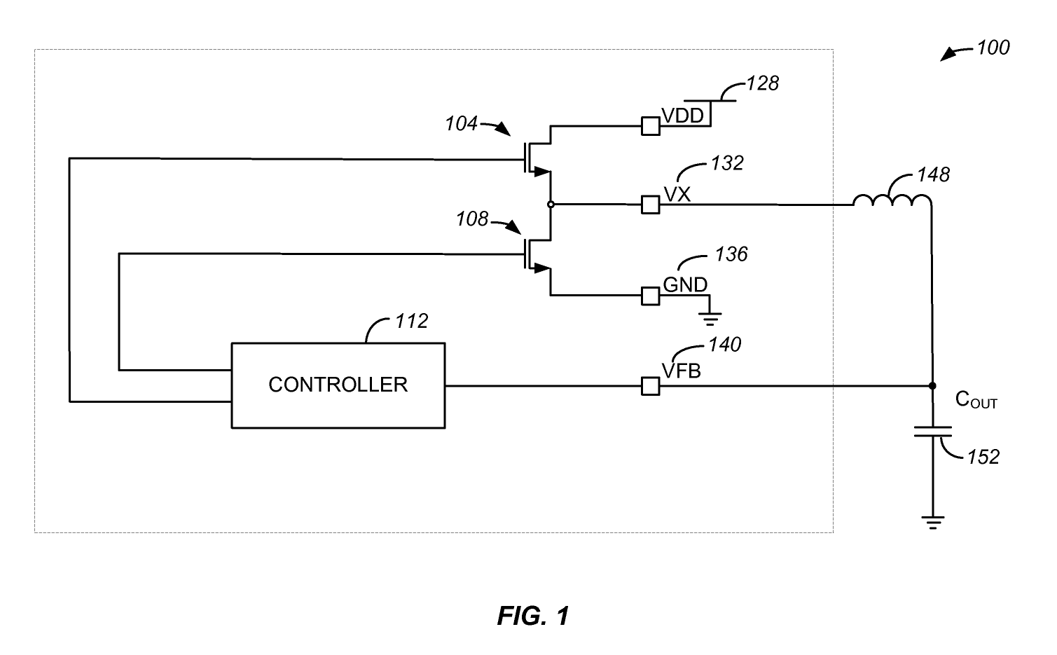

FIG. 1 illustrates the major components of a step-down DC to DC converter 100 that may be employed with various embodiments of the invention. In FIG. 1, DC to DC converter 100 is constructed with a high side FET (switch) 104 and a low side FET (switch) 108. These devices are shown, by way of example, to be n-channel FETs. However, as mentioned above, a wide range of device types may be used. For example, high side FET 104 could be a p-channel device, while low side FET 108 could be replaced with a diode. Again, the range of variation will be appreciated by those of skill in the art.

High side switch 104 is coupled to an input voltage source to be converted and/or regulated (“V_{DD}”) 128, while low side switch 108 is coupled to Ground (“Gnd”) at node 136. A switching node Vx 132 is situated between high side FET 104 and low side FET 108, in particular, between the source of FET 104 and the drain of FET 108. The Vx node is coupled to inductor 148 and output capacitor 152 which are considered at least part of an output filter. The output filter is generally coupled to a load (not shown) such as an integrated circuit. A controller 112 is operatively coupled to control the alternate switching of high side FET 104 and low side FET 108. In some embodiments, controller 112 is coupled to sense a feedback voltage (“V_{FB}”) 140 at the output filter and control the switching at the power switch responsive to this feedback voltage. In other embodiments, the controller may sense other characteristics of the regulator, such as the current flowing through a switch or the inductor, and control the switching responsive to such characteristics.

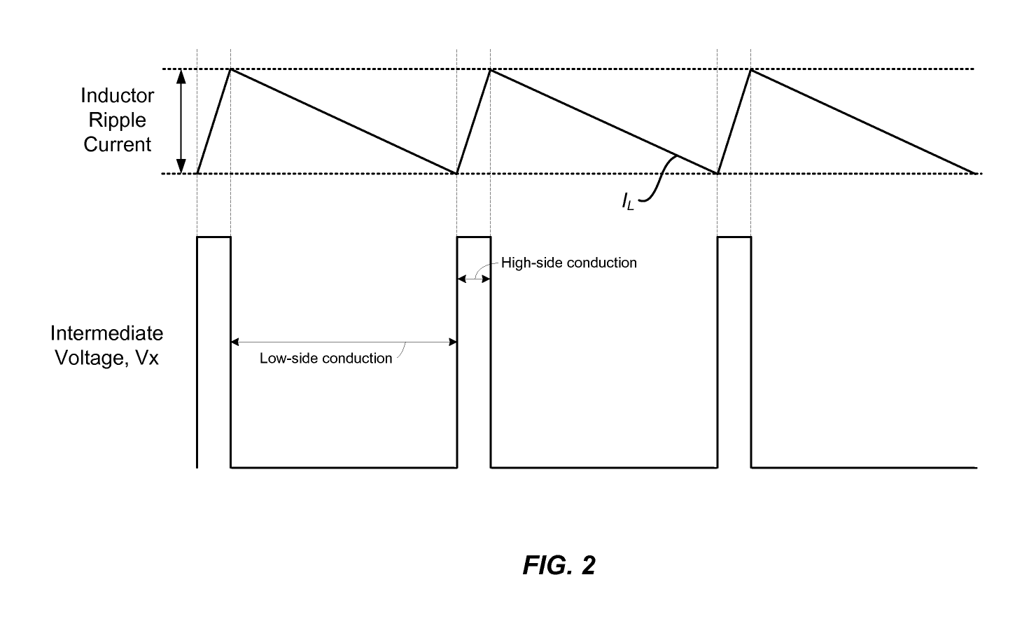

FIG. 2 is an illustration of an inductor ripple current in the output filter of DC to DC converter 100 in relation to the intermediate voltage waveform at node Vx 132 (not to scale). In FIGS. 1 and 2, the current delivered to the inductor 148 of the output filter through node Vx 132, referred to as “I_{L},” ramps up and down in sequence with the switching of high side FET 104 and low side FET 108 of the power switch. In particular, when the high side FET 104 is on, I_{L} ramps up, and when the low side FET 108 is on, I_{L} ramps down. As illustrated, the resulting I_{L} waveform has a saw-tooth shape.

For large voltage conversion ratios (e.g., >10:1), the step down in voltage requires a low duty cycle for a single converter stage, resulting in converter designs that are less efficient, larger, and more costly than converter designs having the same output voltage but higher duty cycles. Therefore, for large conversion ratios, it may be desirable to cascade multiple converter stages with one or more intermediate stage(s) stepping down to one or more intermediate voltage(s) with a higher duty cycle. This approach may result in an overall DC-DC converter solution that is more efficient, smaller and/or lower cost than a single-stage converter with a large voltage conversion ratio.

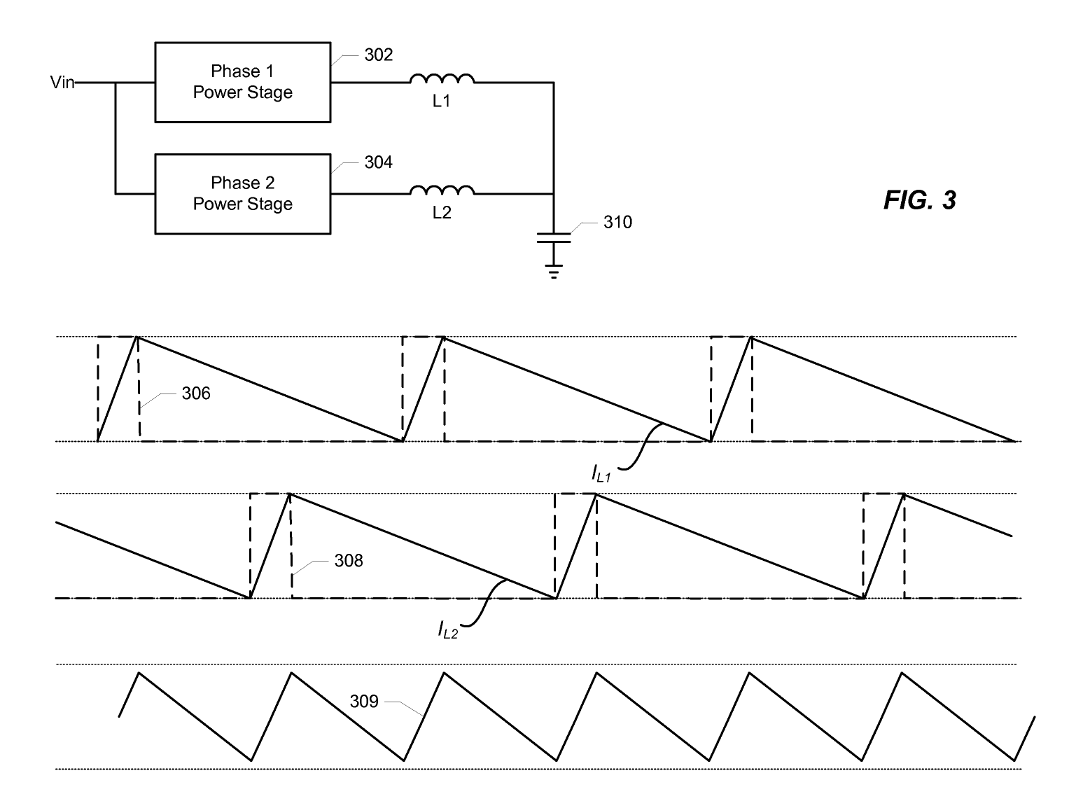

For applications in which large currents (e.g., above 20 amps) are required, it may be useful to have two or more power stages, comprising the power switch and inductor, in parallel to distribute the current load. The operation of these parallel power stages would typically be “interleaved” such that their respective switching waveforms are out of phase with each other by 360/N degrees, i.e., substantially evenly distributed over 360 degrees of phase, where N is the number of parallel power stages. For this reason, the parallel interleaved power stages are often referred to as “phases” of the DC-DC converter. For example, where there are two phases in parallel, the phases operate 180 degrees out of phase with each other; for three, 120 degrees; and so on. One of the reasons for this may be understood with reference to FIG. 3.

FIG. 3 shows the inductor current waveforms I_{L1} and I_{L2} for two parallel phases (power stages 302 and 304 with inductors L1 and L2, respectively) superimposed over the input switching waveforms for each (waveforms are not to scale). The input switching waveforms 306 and 308 illustrate the respective duty cycles for two phases, i.e., the proportion of each cycle during which the input voltage Vin is connected to the load by that phase's power switch. As can be seen, the waveforms for the respective phases are 180 degrees out of phase with each other with the inductor currents I_{L1} and I_{L2} being represented by saw-tooth waveforms having a substantially similar phase relationship. As indicated by combined ripple waveform 309, when the two inductor currents are summed at output capacitor 310, the resulting output ripple waveform has about twice the frequency and is also smaller than the respective inductor currents.

In the case of two interleaved phases as shown in FIG. 3, a 2:1 conversion ratio (i.e., Vout=Vin/2) is advantageous in that it results in a pair of substantially symmetric output ripple waveforms. Under ideal conditions, this symmetry would result in perfect ripple cancellation at the output capacitor as the two symmetric ripple waveforms are 180 degrees out of phase with each other. A similar ripple cancellation effect may be achieved for a 3:1 or 3:2 conversion ratio using three interleaved phases; for a 4:1, 4:2 and 4:3 conversion ratio using four interleaved phases, and so on. More generally, the ideal case of zero current ripple in total output current corresponds to the conversion ratio of N:M, where N is the number of parallel converters and M is an integer 0<M<N. For topologies with a step-up gain, e.g., boost converters, the conversion ratio would be M:N.

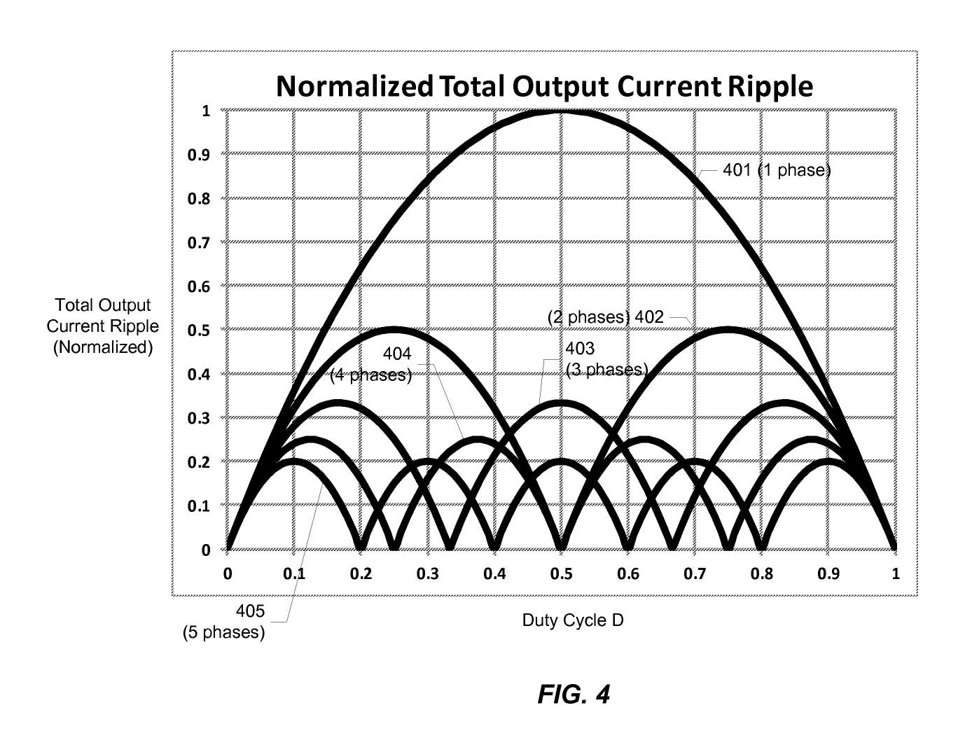

FIG. 4 is an illustration of the normalized total output current ripple (i.e., at the output capacitor) versus duty cycle (i.e., which determines the conversion ratio) for different numbers of parallel phases, and the points at which the greatest ripple cancellation effect can be achieved. Each curve represents a converter stage with a specific number of parallel phases. Curve 401 represents a single phase, curve 402 two parallel phases, curve 403 three parallel phases, curve 404 four parallel phases, and curve 405 five parallel phases. As can be seen from curve 401, the maximum ripple is seen for a single phase when the output voltage is one-half the input voltage (i.e., the duty cycle D=0.5). As expected, the ripple current is zero when there is no switching, i.e., the conversion ratio is zero (the input is never connected to the output), or one (the input is always connected to the output).

As can be seen from curve 402 (the case of two interleaved phases), the total output current ripple is minimized for a step down conversion ratio of 2:1 (D=1/2). Curve 403 (three parallel phases) has ripple current minimums at 3:1 and 3:2 (D=1/3 and D=2/3); curve 404 (four parallel phases) at 4:1, 4:2, and 4:3 (D=1/4, D=1/2, and D=3/4); and curve 405 (five parallel phases) at 5:1, 5:2, 5:3, and 5:4 (D=1/5, D=2/5, D=3/5, and D=4/5). One advantage that should be noted is that, for embodiments having more than two phases in parallel, multiple conversion ratios enjoy the maximum current ripple cancellation benefit, and therefore multiple operational modes corresponding to different conversion ratios can be supported with very low ripple.

Achieving zero or near zero ripple with discrete inductors is potentially beneficial in that it ideally results in little or no ripple current in the output capacitor. Absent other considerations, this means that the output capacitance can be made very small. However, because the ripple cancellation is achieved at the output capacitors while the parallel phases themselves still experience the full current ripple, those phases operate at the same frequency, with the same inductor value, the same current ripple and the same power dissipation as if they were not interleaved. In many applications, output capacitors are sized with respect to design considerations other than output voltage ripple, e.g., load transient tolerance, so the benefit of ripple cancellation in the output capacitors may not result in decreased output capacitance absent other considerations. In addition, parasitic inductance and resistance between the inductors of these parallel phases limit the ripple cancellation that can be achieved in practice.

On the other hand, if the inductors for the parallel phases are magnetically coupled (e.g., by wrapping the windings around the same core, or around cores magnetically coupled to each other), the benefits of ripple cancellation may be extended to the windings and switches. That is, because the inductors are magnetically coupled, a change in current in one of the windings induces a corresponding change in current in the other winding(s). By magnetically coupling the inductors, ripple cancellation (and corresponding reductions in AC conduction losses) is achieved in the inductors, the power switches, layout copper, and any of the converter components instead of just at the output capacitor. This, in turn, allows for the switches to be operated at lower frequency and/or lower current ripple and/or smaller inductor value to decrease the power loss, size and/or cost of the regulator than is possible without coupling. According to various embodiments, the coupling is inverse magnetic coupling, i.e., assuming the currents in all phases have the same direction, the magnetic flux from any winding opposes the magnetic flux from any other winding.

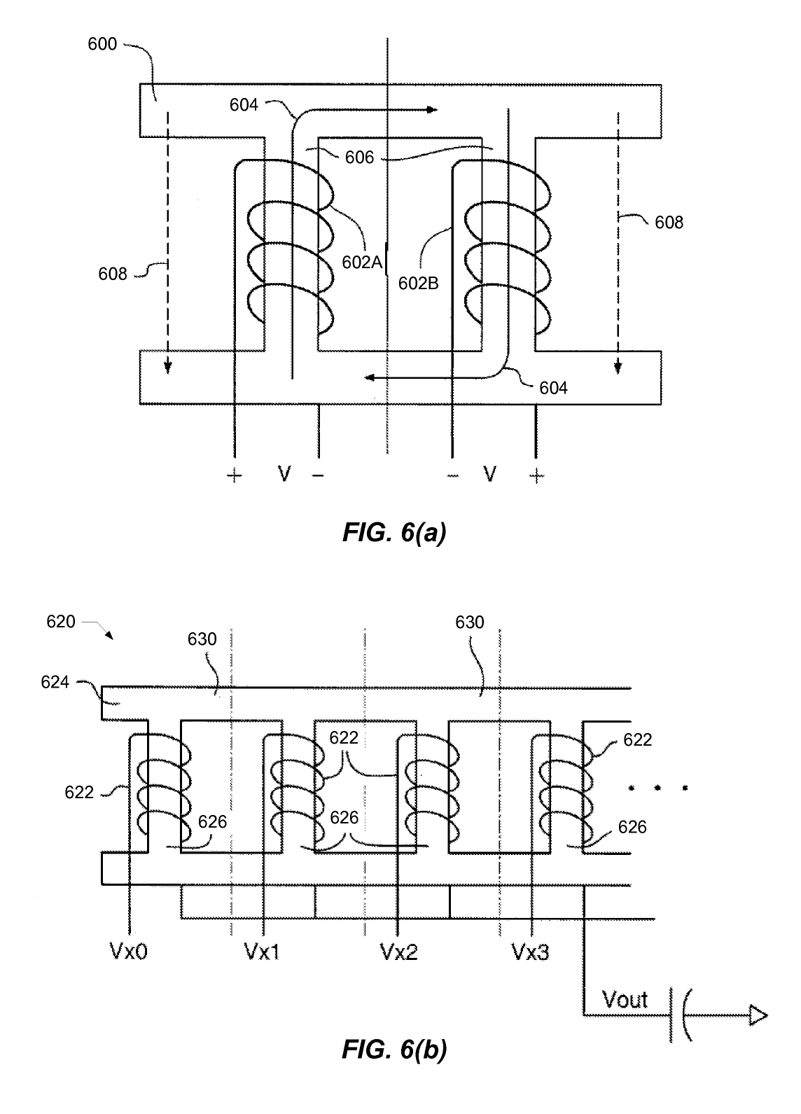

FIGS. 6(a) and 6(b) illustrate some examples in which inductors are magnetically coupled. FIG. 6(a) shows a magnetic core 600 and windings 602A, 602B arranged such that the core has a square shape, including core legs or rungs 606. Windings 602A and 602B are excited with equal voltage magnitudes, but with opposite signs, so that the direction of increase in flux 604 developed in each winding's rung 606 is opposite from the other; and the resulting flux generally flows around the square as shown. Some small leakage flux also flows as shown in dotted lines 608, but since the permeability of the core is generally much higher than that of the medium outside the core (e.g., air), flux 604 chooses core 600 as the permeability path. As a result of the flux following a higher permeability path, the net inductance seen at each winding 602 with this excitation is higher, and thus the net current ripple is lower. According to specific implementations described below, the magnetizing inductance, Lm, of each winding is preferably much higher than the leakage inductance, Ll, of any of the windings; such implementations approaching the zero ripple condition as the ratio Lm/Ll (also referred to herein as σ) approaches infinity, i.e., “perfect” coupling. However, even though Lm is preferably at least about three times Ll, embodiments are contemplated in which this ratio, Lm/Ll, may be even lower, as even poor coupling can, in some cases, reduce current ripple significantly.

The ratio Lm/Ll=σ determines the minimum achievable current ripple. An example may be illustrative. Assuming a DC to DC converter having two parallel phases, the ratio of the resulting ripple to the original ripple (i.e., without coupling) is given by:

resulting ripple/original ripple=(σ+1−D(2σ+1))/((1+2σ)(1−D)), for 0<D<0.5; or

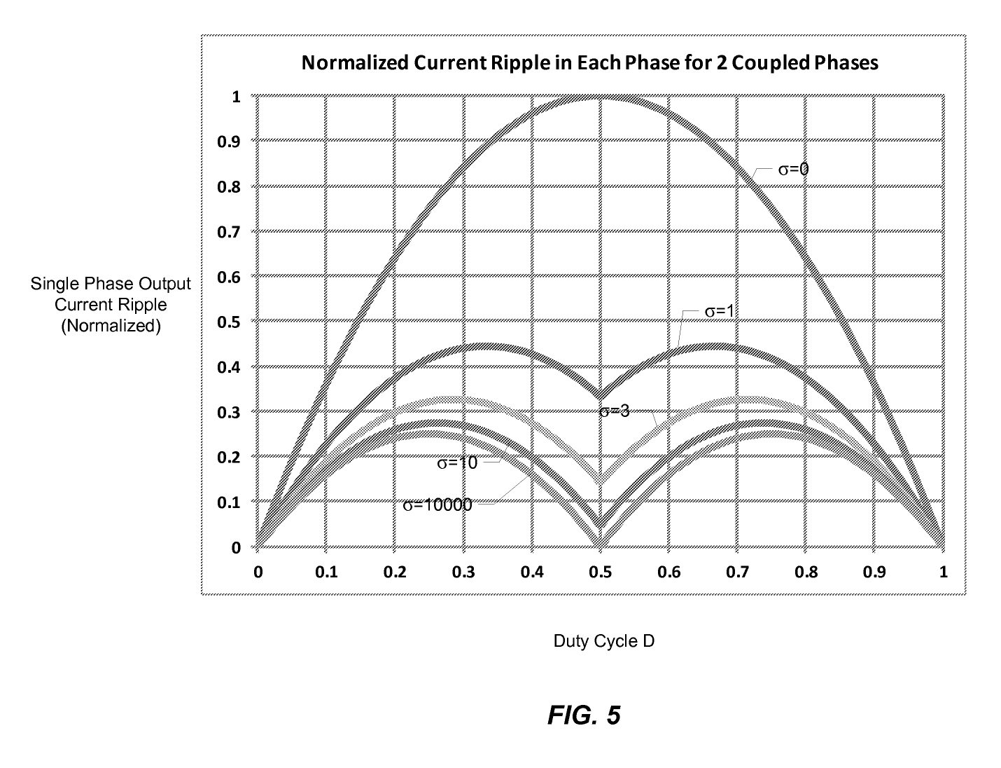

resulting ripple/original ripple=(σ+1−(1−D)(2σ+1))/((1+2σ)(1−(1−D))), for 0.5<D<1

where D is the duty cycle. As σ goes to infinity, i.e., approaching “perfect” coupling, the resulting current ripple is minimized. See, for example, the plot in FIG. 5 in which the output current ripple for one of two parallel phases is shown versus duty cycle D for five values of σ. As can be seen, for σ=10,000 (practically infinite), a substantially zero ripple condition is achieved at D=0.5. It is therefore desirable from a ripple cancellation perspective to make the ratio, σ, larger. However, large values of this ratio correspond to a high propensity for core saturation. So, for implementations having a high ratio of magnetizing to leakage inductance, it becomes increasingly important to provide for DC current balancing among the phases. Techniques for providing such balancing are discussed below.

FIG. 6(b) shows a coupled magnetic structure 620 with more than two windings 622 on a common core 624, each winding corresponding to one of a plurality of parallel phases. Core 624 is in a “ladder” configuration with a plurality of “rungs” 626 coupled with windings 622. In this example, windings 622 are wound with like orientation on rungs 626. It should be understood that the magnetic structures of FIGS. 6(a) and 6(b) are merely examples of how inductors may be magnetically coupled according to specific embodiments of the invention. As will be appreciated by those of skill in the art, a wide variety of structures and mechanisms may be employed to generate opposing magnetic fluxes in the inductors of parallel phases to achieve current ripple reduction in accordance with various embodiments of the invention. For more information regarding the use of magnetically coupled inductors in parallel phases, please refer to U.S. Pat. No. 6,362,986 for Voltage Converter With Coupled Inductive Windings, and Associated Methods issued on Mar. 26, 2002, the entire disclosure of which is incorporated herein by reference for all purposes. For additional examples of inductor structures that may be used with various embodiments of the invention, please also refer to U.S. Patent Publications No. 2011/0043317 for Low Profile Inductors For High Density Circuit Boards, No. 2011/0035607 for Coupled Inductor With Improved Leakage Inductance Control, No. 2011/0032068 for Coupled Inductor With Improved Leakage Inductance Control, No. 2011/0018669 for Low Profile Inductors For High Density Circuit Boards, No. 2009/0237197 for Method For Making Magnetic Components With M-Phase Coupling, And Related Inductor Structures, No. 2009/0231081 for Voltage Converter Inductor Having A Nonlinear Inductance Value, No. 2009/0179723 for Method For Making Magnetic Components With M-Phase Coupling, And Related Inductor Structures, the entire disclosure of each of which is incorporated herein by reference for all purposes. For examples of the use of coupled inductors in isolated topologies that may be configured for ripple cancellation in accordance with various embodiments of the invention, please refer to U.S. Pat. No. 7,463,498 for Apparatus for isolated switching power supply with coupled output inductors, and U.S. Pat. No. 7,239,530 for Apparatus for isolated switching power supply with coupled output inductors, the entire disclosure of each of which is incorporated herein by reference for all purposes.

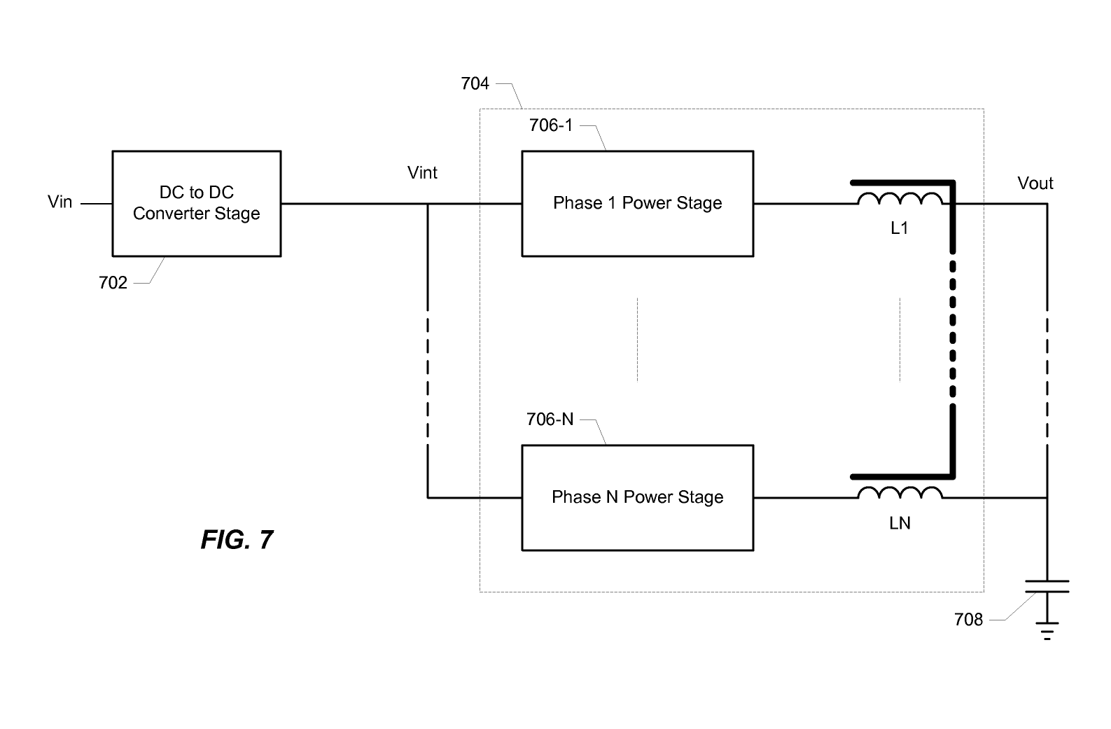

According to a particular class of embodiments, a cascaded DC to DC converter is implemented with a plurality of stages (i.e., two or more) in which a second one of two successive stages includes N parallel phases with N magnetically coupled inductors operating at least 360/N degrees out of phase with each other. A converter stage may include a single switching circuit and inductor, or multiple parallel phases, and may be preceded or followed by one or more additional converter stages. In a step-down implementation, the intermediate voltage between the first and second stages is at or near (N/M)*Vout (where Vout is the output of the second stage and M is an integer 0<M<N). Under ideal conditions this approach results in perfect ripple cancellation in the inductors and power switches of the parallel phases. In practice, the ripple cancellation is not perfect, but those of skill in the art will appreciate the advantages of such a configuration at least some of which are discussed below. FIG. 7 shows a simplified representation of such a DC to DC converter.

DC to DC converter stage 702 receives input voltage Vin and generates an intermediate voltage Vint at or near (N/M)*Vout, i.e., N/M times the output voltage of DC to DC converter stage 704. DC to DC converter stage 702 may be implemented with any of a variety of converter topologies including, for example, Buck, boost, and Buck-boost topologies. As will be understood, the conversion ratio for DC to DC converter stage 704 that is required to achieve the desired degree of ripple cancellation will differ for different converter topologies. That is, for example, in the step-down implementation, e.g., a Buck topology, shown there is a particular voltage gain relation given by Vo=Vin*D, where D is the duty cycle of the converter. This relation corresponds to the conversion ratio discussed above, i.e., Vin=(N/M)*Vout. By contrast, a boost topology, which can be thought of as an inverted Buck (although it is customary to interpret D as the duty cycle for the ground-referenced switch rather than the floating switch as in a Buck topology) the voltage gain relation is given by Vo=Vin*(1/(1−D)). And the voltage gain relation for a Buck-boost is given by Vo=−Vin*(D/(1−D)). Therefore, a more general articulation of the condition required for the near-zero ripple condition enabled by the present invention is represented by the duty cycle for which the condition holds in each of these cases, i.e., that the duty cycle D=M/N.

As will be understood, a wide variety of open-loop or closed-loop control or regulation mechanisms (not shown for the purpose of clarity) known to those of skill in the art may be employed to achieve the desired relationship between the intermediate voltage and the output voltage Vout. As will also be understood, the fidelity with which this relationship is achieved may vary without departing from the scope of the invention. That is, embodiments are contemplated in which the intermediate voltage may deviate from (N/M)*Vout within acceptable limits for a given application. It should also be noted that DC to DC converter 702 may be implemented with one phase, or multiple phases in parallel.

The conversion ratio between the input and output of a converter stage having multiple parallel phases may be maintained in a variety of ways without departing from the scope of the invention. For example, according to some embodiments, the conversion ratio of N:M is used, where N is the number of parallel phases and M is an integer 0<M<N. By maintaining the duty cycles of the respective parallel phases constant at D=M/N, near zero current ripple can be achieved in the parallel phases. As will be understood, this does not by itself guarantee that Vout will be at any specific value. Therefore, according to embodiments in which Vout must be regulated at a specific voltage, the input voltage to the converter stage, e.g., Vint in FIG. 7, may be regulated to (N/M)*Vout. This may be achieved, for example, by an immediately preceding converter stage by sensing Vout or Vint and regulating its output accordingly using any of a wide variety of regulation mechanisms.

Alternatively, the second stage can be configured to regulate its output to the desired Vout, and the preceding stage can be configured to produce an output voltage of (N/M)*Vout. This may be done, for example, using an open loop control scheme, or using a closed loop control scheme that senses Vint, Vout, or both. According to a specific embodiment, and referring again to FIG. 7, the control loop for DC to DC converter stage 702 is a low-bandwidth feedback loop that senses current flowing through one or more power components and/or the voltage at its output (or the output current flowing into (N/M)*Vout rail), and controls the output voltage in a way to achieve minimal ripple in one or more converter stages. According to an alternative embodiment in which stage 702 also has multiple parallel phases configured for ripple cancellation as described herein, the control loop may need to be a high-bandwidth feedback loop to enjoy the various advantages associated with such configurations described below.

DC to DC converter stage 704 includes N parallel phases (i.e., power stages 706-1 through 706-N and respective inductor windings L1 through LN). According to a particular class of implementations illustrated, each phase is implemented using a Buck topology (although other topologies may be used) and is configured to generate an output voltage, Vout. Inductor windings L1 through LN are magnetically coupled as discussed above (and as indicated by the connected thick lines over each). By choosing the input voltage to DC to DC converter stage 704 to be at or near (N/M)*Vout, and by appropriately controlling the relationships among the conduction intervals of the parallel phases, the ripple current in power stages 706-1 through 706-N, inductor windings L1 through LN, and output capacitor 708 may be reduced to near zero. That is, the timing of the N parallel phases is controlled such that the conduction intervals of the phases are spaced evenly over 360 degrees, e.g., the respective power switches of each successive phase is turned on every 360/N degrees, and each operates with a duty cycle D=M/N. Thus, each phase operates at least 360/N degrees out of phase with the other phases.

According to the specific embodiment mentioned above in which the control loop of converter stage 702 is a high-gain, low-bandwidth feedback loop (to assure precise static regulation), the control loop of DC to DC converter stage 704 is a low-gain, high-bandwidth feedback loop which controls the output voltage to assure fast response to dynamic output load. Separation of the bands of operation of the control loops of the successive converter stages reduces the likelihood of interference. Low gain of the feedback in 704 can be also implemented to allow for maintenance of a specified output droop. However, it should be noted that there are a wide variety of schemes that may be employed to maintain the zero or near-zero ripple condition and that the invention is not limited to the specific control loop mechanisms described above.

According to an embodiment in which both of DC to DC converter stages 702 and 704 are implemented with multiple parallel phases configured for ripple cancellation as described herein, a single controller is provided to control the duty cycles for both stages.

According to another embodiment, Vint could be a distribution voltage in an electronic system that is provided via a voltage distribution bus to one or more subsequent converter stages in addition to converter stage 704 and/or one or more loads directly. According to this embodiment, Vint is selected so that DC to DC converter stage 704 enjoys ripple cancellation as described herein, i.e., with reference to the output voltage of converter stage 704, Vout. According to even more specific embodiments in which Vout is adjustable or time-varying, Vint scales accordingly to maintain ripple cancellation. For example, Vout might change in response to a command from its load which might be, for example, a microprocessor, a graphics processor, or an ASIC. Vout might also be adjustable by a user, e.g., by selecting a particular resistor value.

Embodiments of the invention employing magnetically coupled inductors may be characterized by one or more advantages. As discussed above, magnetic coupling of the inductors results in ripple cancellation in each of the corresponding phases (including both the inductors and the power stages) in addition to the output capacitor, thus reducing power dissipation in the switches and the inductors. In addition, it allows the switching frequency of the power switches in the phases to be reduced without suffering large ripple. That is, current ripple in the inductors is inversely proportional to the switching frequency Fs. One strategy for maintaining low ripple involves increasing Fs. However, this proportionally increases switching losses. Thus, there is a fundamental tension between these considerations. However, because embodiments of the invention choose the conversion ratio to reduce ripple close to zero, Fs may be lowered to improve efficiency without an appreciable penalty in power dissipation due to current ripple.

In addition, the value of the inductors may be made correspondingly smaller, thus improving the converter's response to load transients. And because of the improved response to transients, the size of output capacitor may also be correspondingly reduced. Thus, the overall size and cost of regulator and voltage conversion solutions may be significantly reduced.

Another benefit of reducing current ripple is reduced peak current stress which, in turn, reduces voltage spikes induced by parasitic inductance since the power switch switches with lower peak current. This can improve circuit life and reliability, and/or may allow the use of devices rated for lower voltage (with attendant benefits possible in efficiency and cost).

As should be understood with reference to the foregoing, by achieving zero or near-zero ripple with magnetically coupled inductors, the normal design tradeoffs among switching frequency, inductor size, ripple, and efficiency may be reduced or eliminated. In practice, the ripple cancellation in the inductors is not perfect, but the constraints imposed by these traditional design tradeoffs are significantly relaxed.

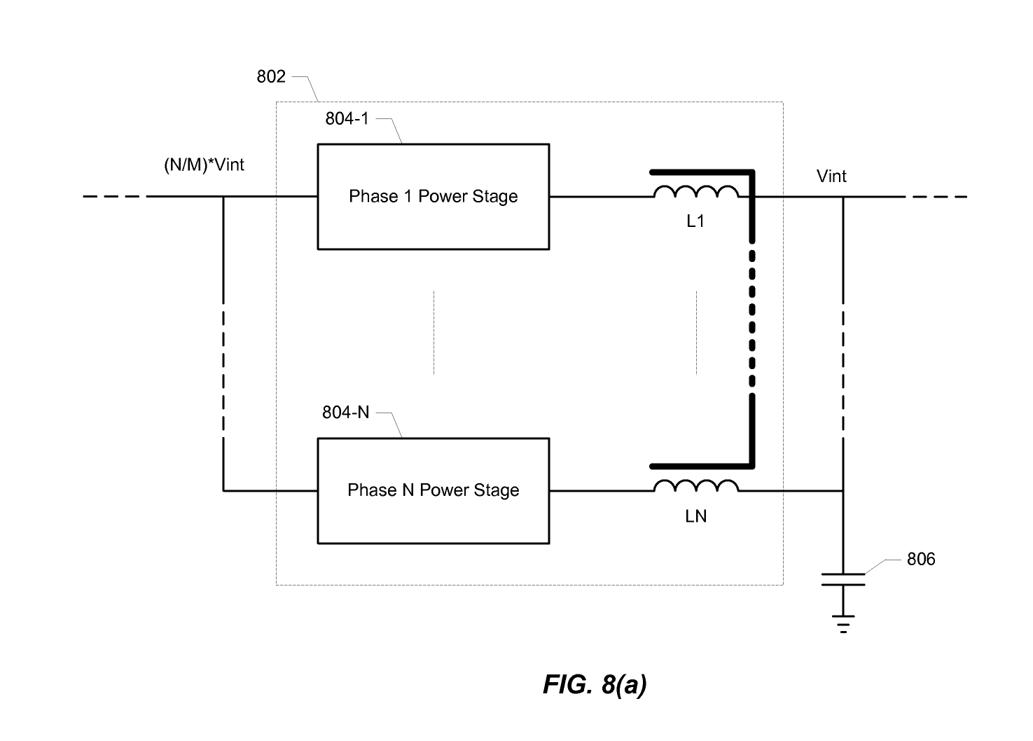

In addition, embodiments are contemplated in which ripple cancellation according to the invention is achieved in one or more stages of a cascaded DC to DC converter preceding the final or output stage (e.g., the first or input stage of a cascaded DC to DC converter, or an intermediate stage of a DC to DC converter between the input stage and the output stage); either as an alternative to, or in addition to ripple cancellation at the output. That is, according to such embodiments, ripple cancellation is employed to reduce ripple associated with intermediate voltage(s) generated by such preceding stage(s). FIGS. 8(a) and 8(b) illustrate examples of such embodiments.

FIG. 8(a) shows a DC to DC converter stage 802 that includes N parallel phases, i.e., power stages 804-1 through 804-N and corresponding inductors L1 through LN; all of which are magnetically coupled. As with the embodiment shown in FIG. 7, each of the parallel phases may be implemented using various converter topologies, with the illustrated example being a Buck topology. In the depicted embodiment, DC to DC converter stage 802 is one of a plurality of two or more cascaded converters stages and is configured to generate intermediate voltage Vint. As with the embodiments shown in FIG. 7, this intermediate voltage is generated from an input voltage which is at or near (N/M)*Vint by controlling the respective parallel phases to have their conduction intervals spaced evenly over 360 degrees, each operating with a duty cycle D=M/N.

FIG. 8(b) shows a DC to DC converter stage 852 that includes N parallel phases, i.e., powers stages 854-1 through 854-N and corresponding inductors L1 through LN; all of which are magnetically coupled. The depicted embodiment is a step-up implementation, e.g., a boost topology, in which the output voltage Vint is generated from an input voltage (M/N)*Vint by appropriately controlling the relationship among the conduction intervals of the respective phases such that the near-zero ripple condition is achieved. As will be understood, a variety of step-up topologies may be employed with such embodiments.

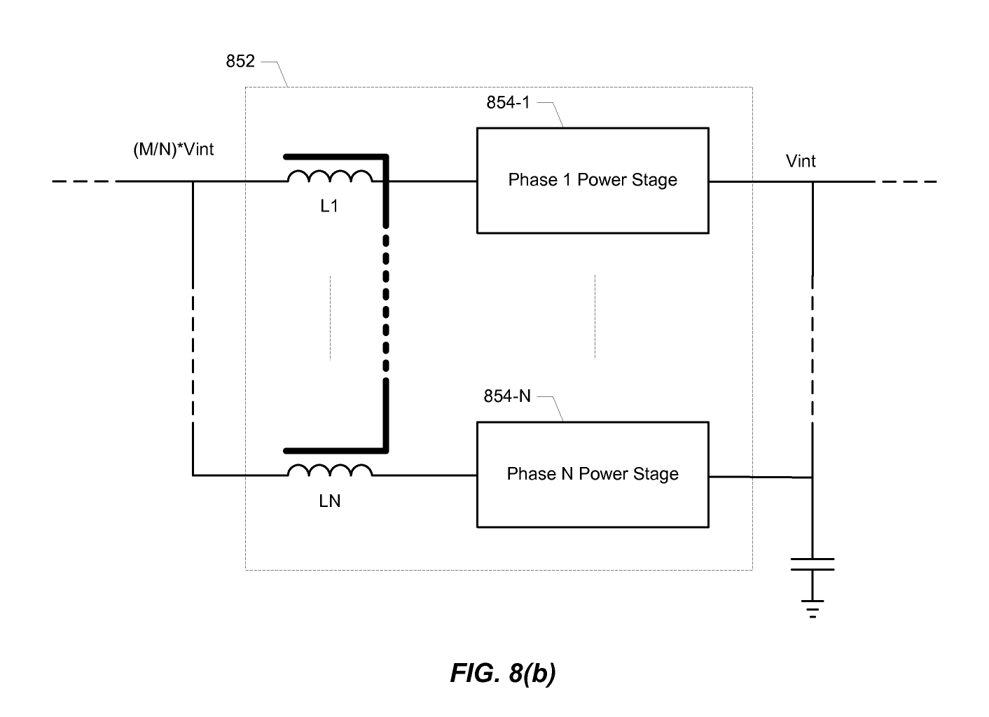

As will be understood by those of skill in the art, the ripple cancellation enabled by the present invention may be implemented in any or all of the stages of a cascaded architecture, including the first stage. One such embodiment is shown in FIG. 9 in which DC to DC converter stage 902 receives an input supply voltage V1 and steps it down to a voltage V2=(M/N)*V1 that may be an intermediate voltage for use by one or more subsequent converter stages and/or supplied directly to one or more loads. That is, the output of DC to DC converter stage 902 may be provided to one or more additional DC to DC converter stages configured to generate a variety of different DC voltages for use with associated loads. In addition, the output of DC to DC converter stage 902, i.e., V2, might be used directly by one or more loads. Such an approach would be advantageous, for example, in an electronic device employing integrated circuits manufactured using various CMOS processes optimized to operate with specific industry standard gate-drive voltages. For example, 0.18 um CMOS process typically has 1.8V gates, 0.25 um CMOS process has 2.5V gates, 0.35 um CMOS process has 3.3V gates, and 0.5 um CMOS process has 5V gates. In such a device, the first DC to DC converter stage (e.g., stage 902) could generate V2=5V, which could then be provided to different DC to DC converter stages (e.g., 904, 906) for stepping down further to 1.8V, 2.5V, and 3.3V and driving associated loads. V2=5V could also be provided directly to one or more loads (e.g., 908, 910). In another example, the first DC to DC converter stage could generate V2=3.3V and the subsequent stages could step up to 5V and down to 2.5V and 1.8V. According to a specific embodiment, the drivers for the power switches in the DC to DC converters may be run from the supply voltage V1, and the controllers for the DC-DC converters may be run from the supply voltage, or another voltage derived from the supply voltage.

And because preceding stages in step-down applications operate with higher input voltages than subsequent stages, because capacitive switching losses increase with the square of the input voltage and with switching frequency, and because semiconductor devices with higher voltage ratings are typically inferior to devices with lower voltage ratings, it is generally desirable to operate such preceding stages at lower frequencies. As discussed above, embodiments of the present invention enable such operation. Such an approach could be advantageous, for example, in an electronic device or system in which an intermediate voltage having near zero ripple could be distributed to one or more converters configured to generate different DC voltages for the various loads.

Implementing a converter stage as described herein that is responsible for regulating a voltage at a load may be advantageous in a variety of ways. However, regardless of how regulation at the load is achieved, and regardless of whether the output voltage of such a final stage is fixed or adjustable in some way, in front of that final stage could be one or more preceding stages configured for current ripple cancellation in accordance with an embodiment of the invention, e.g., a DC to DC converter, with N parallel phases and a voltage step-down conversion ratio of N:M (0<M<N). Such an approach would be particularly advantageous for a large step down in voltage in that the preceding stage(s) could handle much of the step down, generating a voltage in a suitable range for the final stage with near-zero ripple and its attendant advantages, e.g., low switching frequency, smaller inductors, etc. This may also allow the use of devices for the final stage with low voltage ratings with attendant efficiency and cost benefits. It should also be noted that such embodiments are not limited to step down converters.

While the invention has been particularly shown and described with reference to specific embodiments thereof, it will be understood by those skilled in the art that changes in the form and details of the disclosed embodiments may be made without departing from the spirit or scope of the invention. For example, the number of stages as well as the number of parallel phases in a given stage may vary considerably within the scope of the invention and as might be appropriate for particular applications. In one example, a 12 volt DC input voltage is stepped down twice to get a 1 volt DC output voltage. In such a case, it might be suitable to have a first stage with three parallel phases that steps the input voltage to an intermediate voltage of 4 volts DC. A second stage might then have four parallel phases to step the intermediate voltage down to the desired 1 volt DC level. A wide variety of other configurations suitable for particular applications will be apparent to those of skill in the art.

Additionally, embodiments have been discussed herein in which both the input voltage and the output voltage of a DC to DC converter stage including N parallel, magnetically coupled phases are regulated to ensure the desired ratio, e.g., Vin=(N/M)*Vout. However, it should be noted that embodiments are contemplated, for example, in which regulation of only one or the other of the input voltage and output voltage is performed.

Embodiments are also contemplated for applications that require a solution with unregulated voltage gain such as, for example, where a certain voltage rail needs to be stepped down, e.g., a 48V distribution voltage needs to be lowered to 12V local bus voltage. In such embodiments, the unregulated output voltage follows changes and tolerances of the input voltage, and might be used for variety of loads such as, for example, separate voltage converters for different output voltages. According to such embodiments, a converter designed in accordance with the invention having a fixed gain where current ripple cancellation is optimized in the coupled inductors can be used. In the example of a step down from 48V to 12V, four phases (e.g., with Buck topologies) in parallel with coupled inductors could be used, each phase having a duty cycle D=1/4.

As mentioned above, a variety of open-loop and closed-loop control mechanisms may be employed with various implementations to achieve the desired current ripple cancellation for a DC to DC converter having one or more stages designed as described herein. Some examples follow.

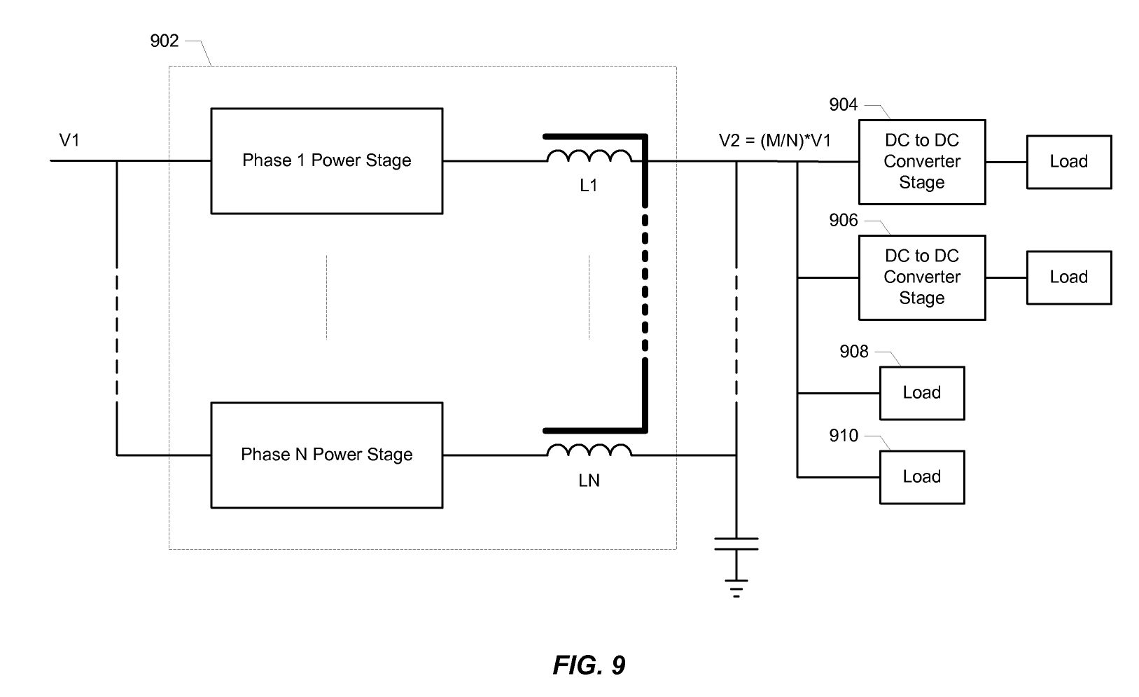

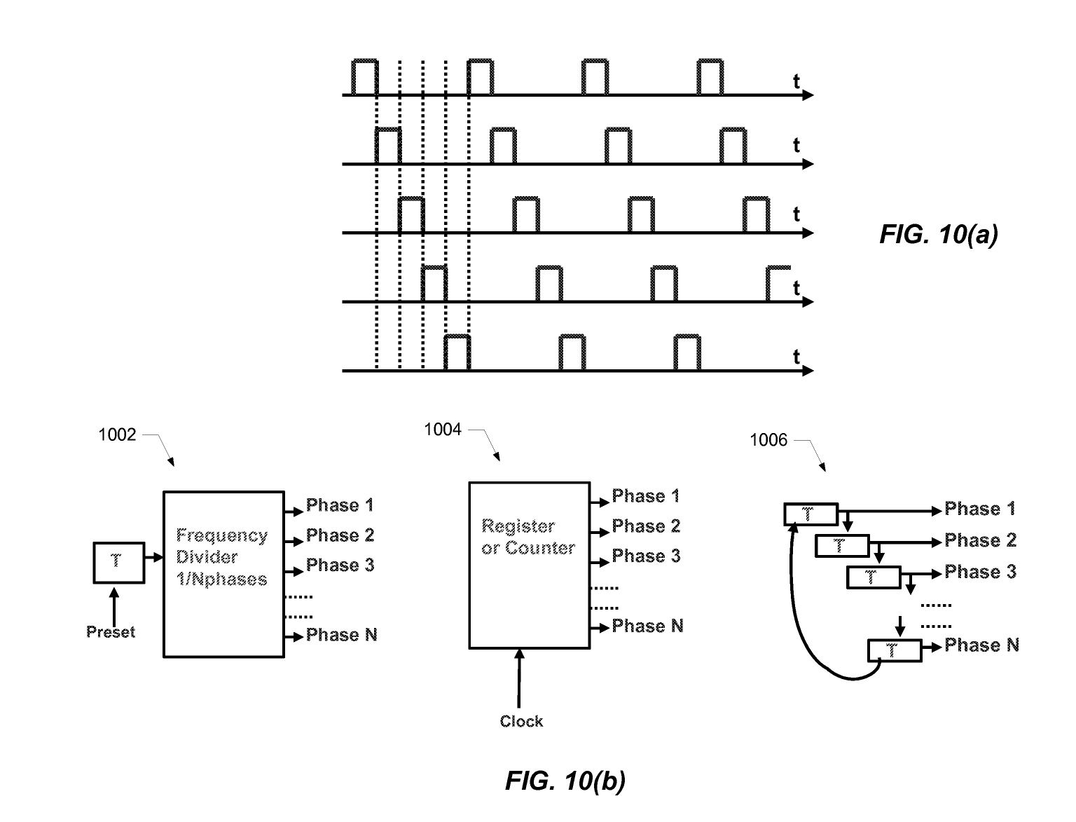

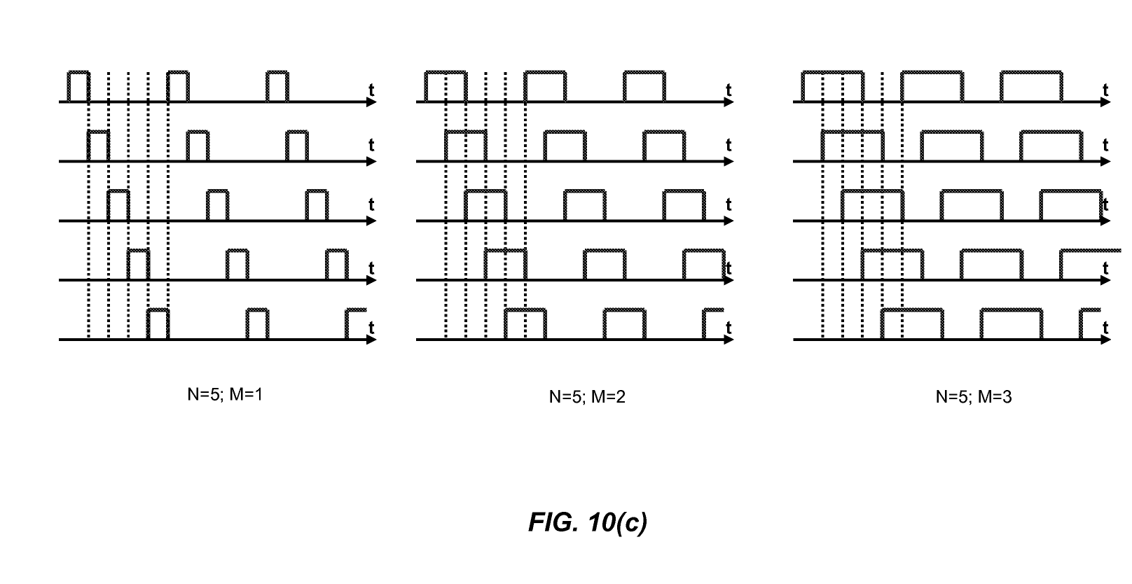

According to specific embodiments of the invention in which the number of parallel phases in a stage is “Nphases,” and in which the duty cycle D=1/Nphases, the duty cycle or on time for each successive phase in the converter stage starts when the duty cycle for the previous phase finishes. This can be understood with reference to FIG. 10(a) in which the relationship among the duty cycles of five parallel phases is illustrated. As discussed above, this phase relationship results in a fixed voltage gain for the converter stage, e.g., a 1/Nphases step down in a Buck converter, an Nphases step up in boost converter, etc. The phase relationship illustrated in FIG. 10(a) can be accomplished simply with logic that does not require closed-loop control. For example, a programmed time pulse T (that defines the switching frequency) may be generated and then frequency divided to generate a train of pulses with no delay between the pulses for successive phases as represented by circuit 1002 of FIG. 10(b) which has been generalized to a converter stage having Nphases parallel phases. Another possible implementation can be a register or counter that generates the successive pulses at successive outputs as represented by circuit 1004 of FIG. 10(b). Yet another approach would be to have a pulse generator in each phase which would start a pulse of duration T triggered by the falling edge of the pulse from the previous phase as represented by circuit 1006 of FIG. 10(b).

It should be noted that the phase relationship illustrated in FIG. 10(a) for a converter stage having 5 parallel phases (e.g., with Buck topologies) corresponds to the minimum of curve 405 of FIG. 4 at 0.2, i.e., where N=5 and M=1. For comparison, phase relationships for this and the minima at 0.4 (M=2) and 0.6 (M=3) are illustrated in FIG. 10(c). As discussed above with reference to FIG. 4, implementations with coupled inductors enjoy the maximum ripple current cancellation enabled by embodiments of the invention at each of these minima, i.e., for each of these phase relationships. And as mentioned above, this makes it possible to configure such a converter stage to have different modes of operation corresponding to different conversion ratios (up or down) while still enjoying the ripple current cancellation enabled by the present invention. As will be understood by those of skill in the art, such modes may be enabled with straightforward logic implemented to reconfigure the voltage gain of the converter stage on the fly.

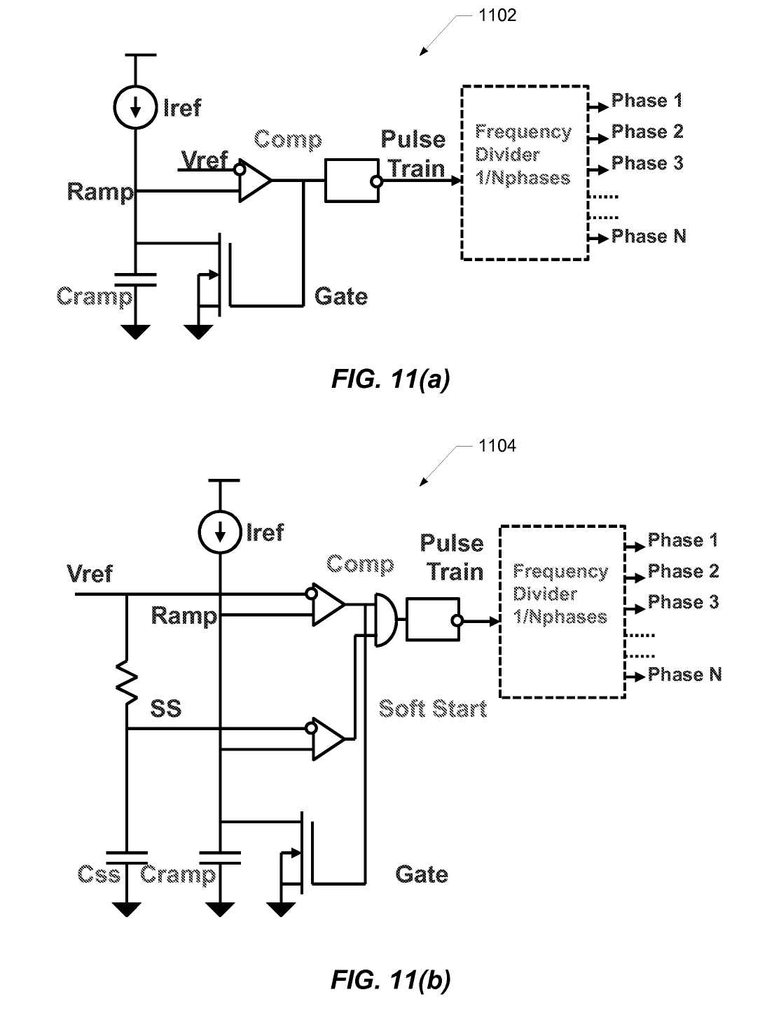

According to specific embodiments of the invention, the source of pulses for the circuits of FIG. 10(b) could be implemented using a conventional saw-tooth generator as shown in circuit 1102 of FIG. 11(a). As discussed above, such a source of pulses can be replicated in each phase, sequentially routed to different phases, or appropriately divided in frequency to provide duty cycle control to each phase. FIG. 11(b) shows an enhanced version of the circuit of FIG. 11(a) in which a “soft start” capability is included to avoid a large step change in current when power is applied. Circuit 1104 includes a slow ramp (SS) that can be charged by a dedicated current source or simple RC circuit connected to the reference voltage Vref. As the “soft start” reference charges up, the duty cycle gradually increases from zero to the maximum.

As will be understood by those of skill in the art, it is desirable for efficiency, reliability, and thermal performance to have currents in the multiple phases of a converter stage be approximately equal. As discussed above, this current balancing is particularly important for implementations having magnetically coupled inductors in which the magnetizing inductance is significantly greater than the leakage inductance. In an open-loop converter, the current share between different phases is maintained passively, being largely determined by the parasitic resistances of the power switches of the respective phases. Current imbalances between phases can also be reduced in such implementations by reducing the switching frequency of the phases so that the timing errors between phases have a smaller impact on the actual duration of pulses and therefore on the current imbalance. Thus, yet another benefit may be derived by the ability to reduce switching frequency enabled by the current ripple cancellation of various embodiments of the invention.

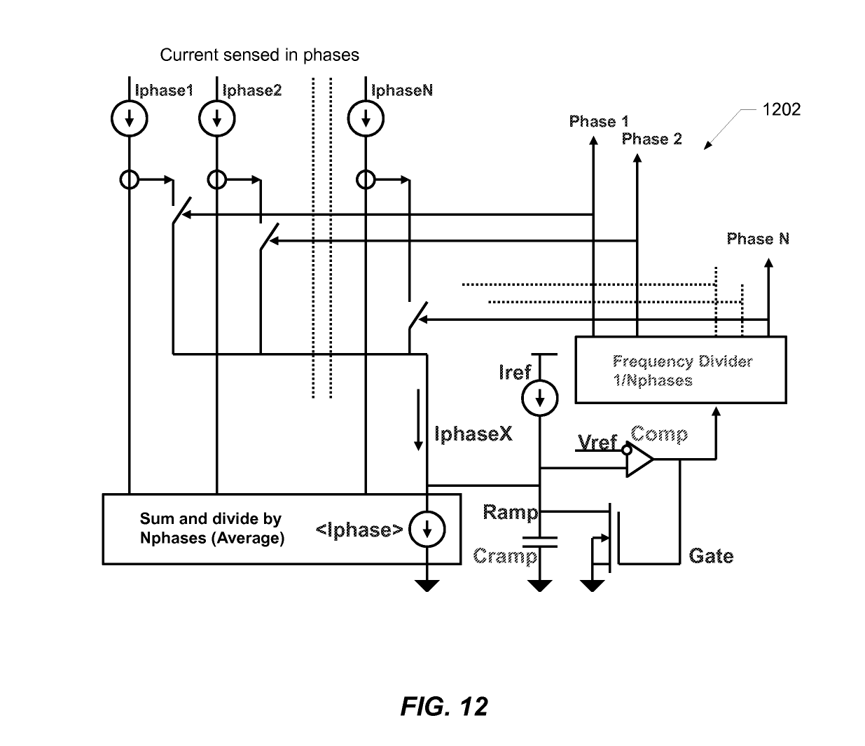

In some implementations, active control of current share among parallel phases in a converter stage may be desirable. However, it is also desirable that any such active control scheme be implemented to have little or no effect on the current ripple cancellation described herein. One approach to implementing such active balancing of current among phases is illustrated in FIG. 12. Active current share circuit 1202 (which includes control circuit 1102 of FIG. 11(a) or may include circuit 1104 of FIG. 11(b)) senses the current in each phase and computes an average. Two currents are added to the Ramp node of the control circuit, i.e., the average phase current is subtracted, while one of the phase currents is added during the on time for the corresponding phase. If the particular phase current is equal to the average phase current, there is no change in the charge/ramp of the voltage on Cᵣₐₘₚ, and therefore no change in the on time interval for the particular phase. However, if, for example, the particular phase current is higher than the average, then Cᵣₐₘₚ will be charged faster, shortening the on time interval for that particular phase, eventually lowering the current in that phase close to the average phase current. This approach effectively forces each phase current back to the average.

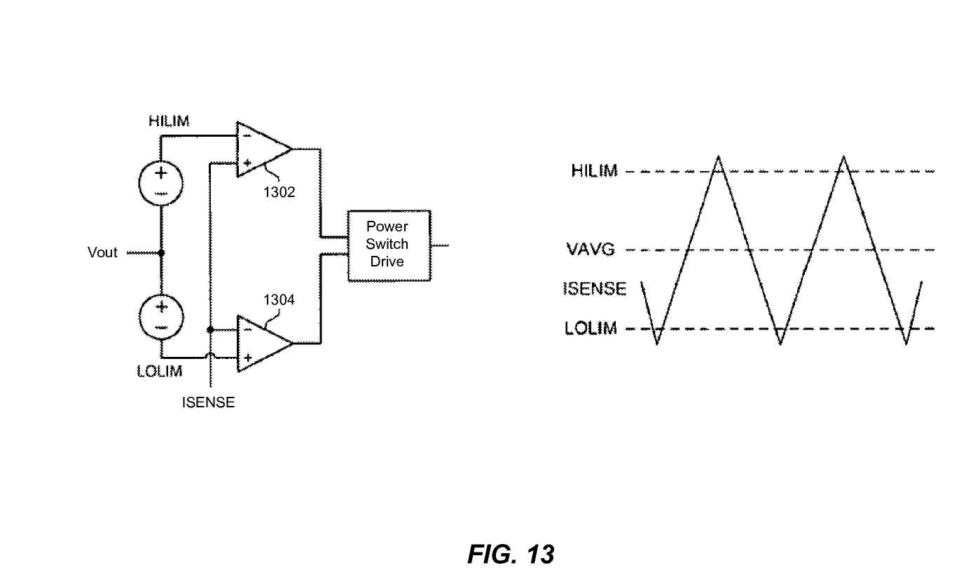

According to another class of embodiments, hysteretic current mode control can be used to maintain current balance among the parallel phases. This technique may be understood with reference to FIG. 13. Each of the parallel phases of the DC to DC converter stage generates a current sense signal ISENSE that is provided as input to related comparators 1302 and 1304. The high and low references, HILIM and LOLIM, are generated with reference to the stage output voltage, Vout, and define the same band of operation for all of the phase currents. The sensed inductor current ISENSE switches between HILIM and LOLIM. When it crosses one of the thresholds, the corresponding comparator trips, switching the power switch of the corresponding phase, and the current for that phase starts ramping in the opposite direction. Because of the magnetic coupling between the inductors of the coupled phases, the currents of the other phases also begin ramping in the same direction. A distinct advantage of this approach is that the switching frequency is determined by the ripple current itself. That is, for a given leakage inductance value and ripple current band (HILIM-LOLIM), the greater the coupling between phases, the lower the switching frequency and higher the efficiency. Embodiments are also contemplated in which only one current reference is used. For example, only a low reference might be used to achieve fixed on-time control. Alternatively, only a high reference might be used to achieve fixed off-time control. Other suitable variations will be apparent to those of skill in the art. For further information relating to current mode control techniques that may be employed with various embodiments of the invention, please refer to U.S. Pat. No. 7,170,267 for Switching Regulator With Average Current Mode Control issued Jan. 30, 2007, the entire disclosure of which is incorporated herein by reference for all purposes.

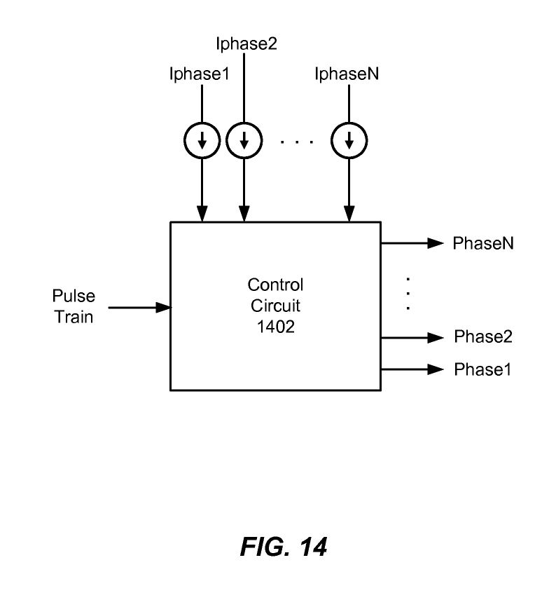

According to yet another class of embodiments, current balance among the parallel phases is maintained using a comparison of all of the phase currents. According to one such embodiment illustrated in FIG. 14, a pulse train is generated such as, for example, the pulse train discussed above with reference to FIGS. 11(a) and 11(b). However, instead of feeding a frequency divider, the pulse train feeds a control circuit 1402 configured such that the rising edge of each pulse triggers a comparison of all of the phase currents (sensed in any of a variety of ways). As a result of the comparison, the phase that is currently conducting is turned off and the phase with the lowest current is turned on.

Active control of current share as described above may be characterized by one or more of the following advantages.

Because the phases follow each other, the duty cycle will stay at or near D=1/Nphases. That is, while the on time of individual phases may be adjusted, the timing for other phases are automatically and correspondingly adjusted such that the average duty cycle will be 1/Nphases. As a consequence, the voltage gain of the converter stage as a whole stays the same, regardless of the current balancing action. Instead, the voltage gain is only affected by voltage droop as current increases due, for example, to parasitics in the circuit (assumed to be very low for efficiency reasons). It will also be appreciated that for the same reason, and again regardless of the current balancing action, the switching frequency remains the same.

According to some embodiments, active control of current share may be implemented simply and inexpensively (e.g., using a single ramp generator with a single comparator, and no error amplifiers) for balancing current in an arbitrary number of phases. In addition, some embodiments have built in noise immunity in that capacitor Cᵣₐₘₚ operates as an integrator, filtering noise spikes in current sense signals to reduce the likelihood of pulse tripping in the middle of an interval.

In addition to the fact that the approach to active control of current share described above does not appreciably interfere with ripple current cancellation, neither does the active control circuitry depend on current ripple in the converter power stages. This is due to the fact that, whether the ripple current is near zero or some larger value, the current waveform for each of the phases is integrated in the same way for all of the phases. This may be advantageous in that the coupling among inductors and the timing between phases are never ideal.

Finally, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A DC to DC converter configured to convert a first voltage, V1, to a second voltage, V2, the DC to DC converter including a first stage and a second stage, the second stage being configured to generate V2 and including N parallel phases, each of the N parallel phases including an inductor and switching circuitry configured to define a conduction interval corresponding to a duty cycle D, the conduction intervals of the respective N parallel phases being substantially evenly distributed over 360 degrees, wherein the inductors of all of the N parallel phases are magnetically coupled to each other, wherein D is about M/N, and wherein M is an integer, 0<M<N.

2. The DC to DC converter of claim 1, wherein the first stage includes K parallel phases, each of the K parallel phases including an inductor and switching circuitry configured to define a conduction interval, the conduction intervals of the respective K parallel phases being substantially evenly distributed over 360 degrees, wherein the inductors of all of the N parallel phases are magnetically coupled to each other.

3. The DC to DC converter of claim 2, wherein each of the conduction intervals of the K parallel phases corresponds to a duty cycle D2, wherein D2 is about L/K, and wherein L is an integer, 0<L<K.

4. The DC to DC converter of claim 3, further comprising a single controller configured to control the duty cycles of the N parallel phases and the duty cycles of the K parallel phases.

5. The DC to DC converter of claim 1, wherein each of the stages employs one of a Buck topology, a boost topology, a Buck-boost topology, or an isolated topology.

6. The DC to DC converter of claim 1, wherein each inductor of each of the N parallel phases comprises a winding wound around a common core shared by all of the inductors.

7. The DC to DC converter of claim 6, wherein each winding is characterized by a leakage inductance and a magnetizing inductance, and wherein the magnetizing inductance of each winding is greater than at least about three times the leakage inductance of any of the windings.

8. The DC to DC converter of claim 1, wherein the first stage is configured to generate an intermediate voltage, Vint, for use by the second stage in generating V2, and wherein the first stage is configured to regulate the intermediate voltage Vint by sensing one or both of Vint and V2.

9. The DC to DC converter of claim 1, wherein the first stage is configured to generate an intermediate voltage, Vint, for use by the second stage in generating V2, and wherein the first stage is configured to generate the intermediate voltage Vint using an open-loop control mechanism.

10. The DC to DC converter of claim 9, wherein the first stage is configured to operate in accordance with one or more duty cycles, and wherein the open-loop control mechanism selects the one or more duty cycles.

11. The DC to DC converter of claim 1, wherein the first stage is configured to generate an intermediate voltage, Vint, for use by the second stage in generating V2, wherein the first and second stages are configured to independently regulate Vint and V2, respectively, and wherein a control loop of the second stage has a bandwidth higher than a bandwidth of a control loop of the first stage.

12. The DC to DC converter of claim 1, further comprising open-loop control circuitry configured to maintain the duty cycles of the N parallel phases.

13. The DC to DC converter of claim 1, further comprising closed-loop control circuitry configured to maintain V2 with reference to one or more operational parameters of the N parallel phases.

14. The DC to DC converter of claim 13, wherein the one or more operational parameters comprises a current associated with each of the N parallel phases.

15. The DC to DC converter of claim 14, wherein the closed-loop control circuitry is configured to compute an average of the currents and to force each of the currents toward the average.

16. The DC to DC converter of claim 14, wherein the closed-loop control circuitry is configured to sense the current associated with each of the phases and to switch a first one of the N parallel phases in response to the corresponding current crossing a threshold defined with reference to V2.

17. The DC to DC converter of claim 16, wherein the threshold comprises one or either of a high current threshold or a low current threshold.

18. The DC to DC converter of claim 14, wherein the closed-loop control circuitry is configured to sense the current associated with each of the phases and to switch a first one of the N parallel phases on in response to the corresponding current being a lowest one of the currents of all of the phases.

19. A DC to DC converter configured to convert a first voltage, V1, to a second voltage, V2, the DC to DC converter comprising N parallel phases configured to receive V1 and generate V2, each of the N parallel phases including an inductor and switching circuitry configured to define a conduction interval corresponding to a duty cycle D, the conduction intervals of the respective N parallel phases being substantially evenly distributed over 360 degrees, wherein the inductors of all of the N parallel phases are magnetically coupled to each other, wherein D is about M/N, and wherein M is an integer, 0<M<N.

20. The DC to DC converter of claim 19, wherein the DC to DC converter employs one of a Buck topology, a boost topology, a Buck-boost topology, or an isolated topology.

21. The DC to DC converter of claim 19, wherein each inductor of each of the N parallel phases comprises a winding wound around a common core shared by all of the inductors.

22. The DC to DC converter of claim 21, wherein each winding is characterized by a leakage inductance and a magnetizing inductance, and wherein the magnetizing inductance of each winding is greater than at least about three times the leakage inductance of any of the windings.

23. The DC to DC converter of claim 19, further comprising open-loop control circuitry configured to maintain the duty cycles of the N parallel phases.

24. The DC to DC converter of claim 19, further comprising closed-loop control circuitry configured to maintain V2 with reference to one or more operational parameters of the N parallel phases.

25. The DC to DC converter of claim 24, wherein the one or more operational parameters comprises a current associated with each of the N parallel phases.

26. The DC to DC converter of claim 25, wherein the closed-loop control circuitry is further configured to compute an average of the currents and to force each of the currents toward the average.

27. The DC to DC converter of claim 25, wherein the closed-loop control circuitry is configured sense the current associated with each of the phases and to switch a first one of the N parallel phases in response to the corresponding current crossing a threshold defined with reference to V2.

28. The DC to DC converter of claim 27, wherein the threshold comprises one or either of a high current threshold or a low current threshold.

29. The DC to DC converter of claim 25, wherein the closed-loop control circuitry is configured to sense the current associated with each of the phases and to switch a first one of the N parallel phases on in response to the corresponding current being a lowest one of the currents of all of the phases.

30. The DC to DC converter of claim 19 wherein the N parallel phases are included in one of a plurality of stages of the DC to DC converter, and wherein the stage of the DC to DC converter including the N parallel phases comprises one of an input stage, an intermediate stage, or an output stage of the DC to DC converter.

31. An electronic system comprising a plurality of DC to DC converters configured to generate a plurality of different DC voltages for use by a plurality of loads, a first one of the DC to DC converters comprising N parallel phases configured to receive an input voltage, V1, and generate an intermediate voltage, Vint, each of the N parallel phases including an inductor and switching circuitry configured to define a conduction interval corresponding to a duty cycle D, the conduction intervals of the respective N parallel phases being substantially evenly distributed over 360 degrees, wherein the inductors of all of the N parallel phases are magnetically coupled to each other, wherein D is about M/N, wherein M is an integer, 0<M<N, the electronic system further comprising a bus for distributing Vint to others of the DC to DC converters for generation of at least some of the plurality of different DC voltages.

32. The electronic system of claim 31, wherein a second one of the DC to DC converters is configured to receive Vint via the bus and includes K parallel phases, each of the K parallel phases including an inductor and switching circuitry configured to define a conduction interval corresponding to a duty cycle D2, the conduction intervals of the respective K parallel phases being substantially evenly distributed over 360 degrees, wherein the inductors of all of the K parallel phases are magnetically coupled to each other, wherein D2 is about L/K, and wherein L is an integer, 0<L<K.

33. The electronic system of claim 31, wherein Vint is one of the different DC voltages employed by a subset of the plurality of loads.

34. The electronic system of claim 31, wherein the plurality of different DC voltages include two or more of 1.8V, 2.5V, 3.3V, or 5V.

35. The electronic system of claim 34, wherein at least one of the two or more of 1.8V, 2.5V, 3.3V, or 5V provides a gate-drive supply voltage for one or more of the DC to DC converters.

36. The electronic system of claim 34, wherein Vint is one of the 1.8V, 2.5V, 3.3V, or 5V.

37. The electronic system of claim 34, wherein at least one of the two or more of 1.8V, 2.5V, 3.3V, or 5V provides a voltage supply for a controller associated with one or more of the DC to DC converters.

38. The electronic system of claim 31, wherein the switching circuitry for each of the N parallel phases comprises a power switch and a driver configured to drive the power switch, and wherein V1 supplies power to the driver.

39. The electronic system of claim 38, wherein the switching circuitry further comprises a controller configured to provide a drive signal to the driver, and wherein V1 supplies power to the controller.

40. The electronic system of claim 31, wherein each of the DC to DC converters employs one of a Buck topology, a boost topology, a Buck-boost topology, or an isolated topology.

41. The electronic system of claim 31, wherein each inductor of each of the N parallel phases comprises a winding wound around a common core shared by all of the inductors.

42. The electronic system of claim 41, wherein each winding is characterized by a leakage inductance and a magnetizing inductance, and wherein the magnetizing inductance of each winding is greater than at least about three times the leakage inductance of any of the windings.

43. The electronic system of claim 31, further comprising open-loop control circuitry configured to maintain the duty cycles of the N parallel phases.

44. The electronic system of claim 31, further comprising closed-loop control circuitry configured to maintain Vint with reference to one or more operational parameters of the N parallel phases.

45. The electronic system of claim 44, wherein the one or more operational parameters comprises a current associated with each of the N parallel phases.

46. The electronic system of claim 45, wherein the closed-loop control circuitry is configured to compute an average of the currents and to force each of the currents toward the average.

47. The electronic system of claim 45, wherein the closed-loop control circuitry is configured sense the current associated with each of the phases and to switch a first one of the N parallel phases in response to the corresponding current crossing a threshold defined with reference to Vint.

48. The electronic system of claim 47, wherein the threshold comprises one or either of a high current threshold or a low current threshold.

49. The electronic system of claim 45, wherein the closed-loop control circuitry is configured to sense the current associated with each of the phases and to switch a first one of the N parallel phases on in response to the corresponding current being a lowest one of the currents of all of the phases.

50. An electronic system comprising a plurality of DC to DC converters configured to generate a plurality of different DC voltages for use by a plurality of loads, a particular one of the DC to DC converters having N parallel phases configured to receive a distribution voltage, Vdist, and generate an output voltage, Vout, for use by a corresponding one of the loads, each of the N parallel phases including an inductor and switching circuitry configured to define a conduction interval corresponding to a duty cycle D, the conduction intervals of the respective N parallel phases being substantially evenly distributed over 360 degrees, wherein the inductors of all of the N parallel phases are magnetically coupled to each other, wherein D is about M/N, and wherein M is an integer, 0<M<N, the electronic system further comprising a bus for distributing Vdist to others of the DC to DC converters for generation of at least some of the plurality of different DC voltages.

51. The electronic system of claim 50, wherein Vdist is selected with reference to Vout, and wherein Vout is time-varying, Vdist scaling with Vout to maintain Vout at about (M/N)*Vdist.

52. The electronic system of claim 50, wherein Vout changes in response to a command from the corresponding load, and wherein Vdist scales with Vout to maintain Vout at about (M/N)*Vdist.

53. The electronic system of claim 50, wherein each of the DC to DC converters employs one of a Buck topology, a boost topology, a Buck-boost topology, or an isolated topology.

54. The electronic system of claim 50, wherein each inductor of each of the N parallel phases comprises a winding wound around a common core shared by all of the inductors.

55. The electronic system of claim 54, wherein each winding is characterized by a leakage inductance and a magnetizing inductance, and wherein the magnetizing inductance of each winding is greater than at least about three times the leakage inductance of any of the windings.

56. The electronic system of claim 50, further comprising open-loop control circuitry configured to maintain the duty cycles of the N parallel phases.

57. The electronic system of claim 50, further comprising closed-loop control circuitry configured to maintain Vout with reference to one or more operational parameters of the N parallel phases.

58. The electronic system of claim 57, wherein the one or more operational parameters comprises a current associated with each of the N parallel phases.

59. The electronic system of claim 58, wherein the closed-loop control circuitry is configured to compute an average of the currents and to force each of the currents toward the average.

60. The electronic system of claim 58, wherein the closed-loop control circuitry is configured sense the current associated with each of the phases and to switch a first one of the N parallel phases in response to the corresponding current crossing a threshold defined with reference to Vout.

61. The electronic system of claim 60, wherein the threshold comprises one or either of a high current threshold or a low current threshold.

62. The electronic system of claim 58, wherein the closed-loop control circuitry is configured to sense the current associated with each of the phases and to switch a first one of the N parallel phases on in response to the corresponding current being a lowest one of the currents of all of the phases.

63. The electronic system of claim 50, wherein Vdist is selected with reference to Vout, and wherein Vout is adjustable, Vdist scaling with Vout to maintain Vout at about (M/N)*Vdist.

64. A DC to DC converter configured to convert a first voltage, V1, to a second voltage, V2, the DC to DC converter comprising N parallel phases configured to receive V1 and generate V2, each of the N parallel phases including an inductor and switching circuitry configured to define a conduction interval corresponding to a duty cycle, and wherein the inductors of all of the N parallel phases are magnetically coupled to each other, the DC to DC converter further comprising closed-loop control circuitry configured to maintain V2 with reference to one or more operational parameters of the N parallel phases, and to maintain currents associated with each of the N parallel phases to be substantially equal, thereby maintaining a substantially zero ripple current condition in the switching circuitry and the output conductors of the N parallel phases.

65. The DC to DC converter of claim 64, wherein the one or more operational parameters comprises the currents associated with each of the N parallel phases.

66. The DC to DC converter of claim 65, wherein the closed-loop control circuitry is configured to compute an average of the currents and to force each of the currents toward the average.

67. The DC to DC converter of claim 65, wherein the closed-loop control circuitry is configured to sense the current associated with each of the phases and to switch a first one of the N parallel phases in response to the corresponding current crossing a threshold defined with reference to V2.

68. The DC to DC converter of claim 67, wherein the threshold comprises one or either of a high current threshold or a low current threshold.

69. The DC to DC converter of claim 65, wherein the closed-loop control circuitry is configured to sense the current associated with each of the phases and to switch a first one of the N parallel phases on in response to the corresponding current being a lowest one of the currents of all of the phases.

70. The DC to DC converter of claim 64, wherein the DC to DC converter employs one of a Buck topology, a boost topology, a Buck-boost topology, or an isolated topology.

71. The DC to DC converter of claim 64, wherein each inductor of each of the N parallel phases comprises a winding wound around a common core shared by all of the inductors.

72. The DC to DC converter of claim 71, wherein each winding is characterized by a leakage inductance and a magnetizing inductance, and wherein the magnetizing inductance of each winding is greater than at least about three times the leakage inductance of any of the windings.

73. A DC to DC converter configured to convert a first voltage, V1, to a second voltage, V2, the DC to DC converter comprising N parallel phases configured to receive V1 and generate V2, each of the N parallel phases including an inductor and switching circuitry, the inductors of all of the N parallel phases being magnetically coupled to each other, the DC to DC converter further comprising closed-loop control circuitry configured to maintain currents associated with each of the N parallel phases to be substantially equal by sensing the current associated with each of the phases and switching a first one of the N parallel phases in response to the corresponding current crossing a threshold.

74. A DC to DC converter configured to convert a first voltage, V1, to a second voltage, V2, the DC to DC converter comprising N parallel phases configured to receive V1 and generate V2, each of the N parallel phases including an inductor and switching circuitry, the inductors of all of the N parallel phases being magnetically coupled to each other, the DC to DC converter further comprising closed-loop control circuitry configured to maintain currents associated with each of the N parallel phases to be substantially equal by computing an average of the currents and forcing each of the currents toward the average.

75. A DC to DC converter configured to convert a first voltage, V1, to a second voltage, V2, the DC to DC converter comprising N parallel phases configured to receive V1 and generate V2, each of the N parallel phases including an inductor and switching circuitry, the inductors of all of the N parallel phases being magnetically coupled to each other, the DC to DC converter further comprising closed-loop control circuitry configured to maintain currents associated with each of the N parallel phases to be substantially equal by sensing the current associated with each of the phases and switching a first one of the N parallel phases on in response to the corresponding current being a lowest one of the currents of all of the phases.
